(19) United States
(12) Patent Application Publication
(10) Pub. No.: US 2007/0237176 A1
(43) Pub. Date: Oct. 11, 2007

(54) System and method for enhancing data speed over communication lines

(75) Inventors: Timothy Alan Bartlett, Antelope, CA (US); Goangshiuan Shawn Ying, Oakland, CA (US)

Correspondence Address: PAUL S MADAN;MADAN, MOSSMAN & SRIRAM, PC, 2603 AUGUSTA DRIVE, SUITE 700, HOUSTON, TX, 77057-5662, US

(73) Assignee: SBC Knowledge Ventures L.P., Reno, NV (US)

(21) Appl. No.: 11/394,148

(22) Filed: Mar. 30, 2006

(51) Int. Cl. H04J 3/22

(52) U.S. Cl. 370/468; 370/521

(57) ABSTRACT

The present disclosure provides a system and method for compressing data in a communications network. The downstream data is compressed at a network element and sent to a customer premises over a data communication link, and is decompressed by a device at the customer end. The upstream data is compressed by the device at the customer end and decompressed by the network element.

### BACKGROUND OF THE DISCLOSURE

1. Field of the Disclosure

The present disclosure relates to communication networks that provide content over communication lines linked to customer premises equipment.

2. Description of the Related Art

Communication networks, such as Digital Subscriber Line (DSL) networks and cable networks are capable of providing a wide variety of services, including access to the Internet, Internet Protocol Television (IPTV), voice services, Video-on-Demand (VoD), and access to a large number of content providers, such as providers of financial services, data searches, photo shops, interactive services, such as gaming, etc. Typically, such services are provided from a network element at a service provider's network to customer premises equipment over a data communications link, such as a digital subscriber line, cable or a satellite connection. The DSL typically is a pair of copper wires or optical fiber and the cable is typically a co-axial cable or a hybrid coaxial and fiber connection. Satellite systems use wireless connections. Customer premises equipment (CPE) often includes a DSL modem, residential gateway, such as a router, set-top-box and computer for exchanging content with the network elements.

Generally, the amount of downstream data (data from the network elements to the CPE) is substantially greater than the amount of upstream data (from CPE to the network elements) and thus the downstream data transfer uses higher bandwidth or higher available bit rate compared to the upstream available bit rate. The data transfer needs, however, for both the downstream and upstream data are continuously increasing and in certain cases the communication lines may not be able to handle the data requirements without degradation in the quality of service or installation of newer or shorter lines between the network elements and the CPE. Thus, there is a need for an improved system and method for transferring data between the CPE and network elements.

### BRIEF DESCRIPTION OF THE DRAWINGS

For detailed understanding of the present invention, references should be made to the following detailed description of the embodiments, taken in conjunction with the accompanying drawings, in which like elements have been given like numerals, wherein:

FIG. 1 is a functional diagram of an example of a network that can provide network services according to one embodiment of the present disclosure;

FIG. 2 is a functional diagram of a data compression/decompression system for use between CPE and an Asynchronous Transfer Mode (ATM) network according to one embodiment of the present disclosure;

FIG. 3 is a functional diagram of a data compression/decompression system for use between CPE and an Internet Protocol (IP) network according to one embodiment of the present disclosure;

FIG. 4 is a functional diagram of a data compression/decompression system for use between CPE and a Packet Cable Network according to one embodiment of the present disclosure;

FIG. 5 is a flowchart showing a method according to one embodiment of the present disclosure; and

FIG. 6 is a diagrammatic representation of a machine in the form of a computer system within which a set of instructions, when executed, may cause the machine to perform any one or more of the methodologies discussed herein.

### DETAILED DESCRIPTION OF THE EMBODIMENTS

The disclosure, in one aspect, provides a computer-readable medium accessible to a processor for executing instructions contained in a computer program embedded in the computer-readable medium, wherein the computer program includes: instructions to receive a compressed first data stream as a downstream data from a network element of a network over a data communication link; instructions to decompress the compressed first data stream; instructions to provide the decompressed first data stream to a customer premises equipment (CPE); instructions to receive a second data stream from the CPE for transmission to the network element as upstream data; instructions to compress the second data stream; and instructions to transmit the compressed second data stream as upstream data to the network element over the data communication link. The computer program further comprises instructions to decompress the compressed second data stream and compress the first data stream. The data communication link may be any suitable link including a digital subscriber line, cable, or wireless link.

The network element may be any suitable device, including a digital subscriber line access multiplexer (DSLAM); cable network interface; wireless network interface; or stand-alone server. The first data stream and the second data stream each may be associated with an Asynchronous Transfer Mode DSL Network, an Internet Protocol DSL network or a Cable Packet network. The computer program may reside in a DSL modem, Residential Gateway, computer, or cable modem. The computer program may use different ratios for compression and decompression of the data.

The disclosure also provides an apparatus for use as an interface between a CPE and a communications network that provides content to the CPE over a data communication link. The apparatus includes a processor; a computer-readable medium accessible to the processor for executing instructions contained in the computer program embedded in the computer-readable medium, wherein the computer program comprises instructions to receive a compressed first data stream as a downstream data from a network element of the communication network over a data communication link; instructions to decompress the compressed first data stream; instructions to provide the compressed first data stream to a customer premises equipment (CPE); instructions to receive a second data stream from the CPE for transmission to the network element as upstream data; instructions to compress the second data stream; and instructions to transmit the compressed second data stream as upstream data to the network element over the data communication link.

The disclosure also provides a method that includes: decompressing downstream network data received over a communication link from a network for a client application; and compressing client application data received from the client application before transmission of the client application data as upstream data over the communication line to the network.

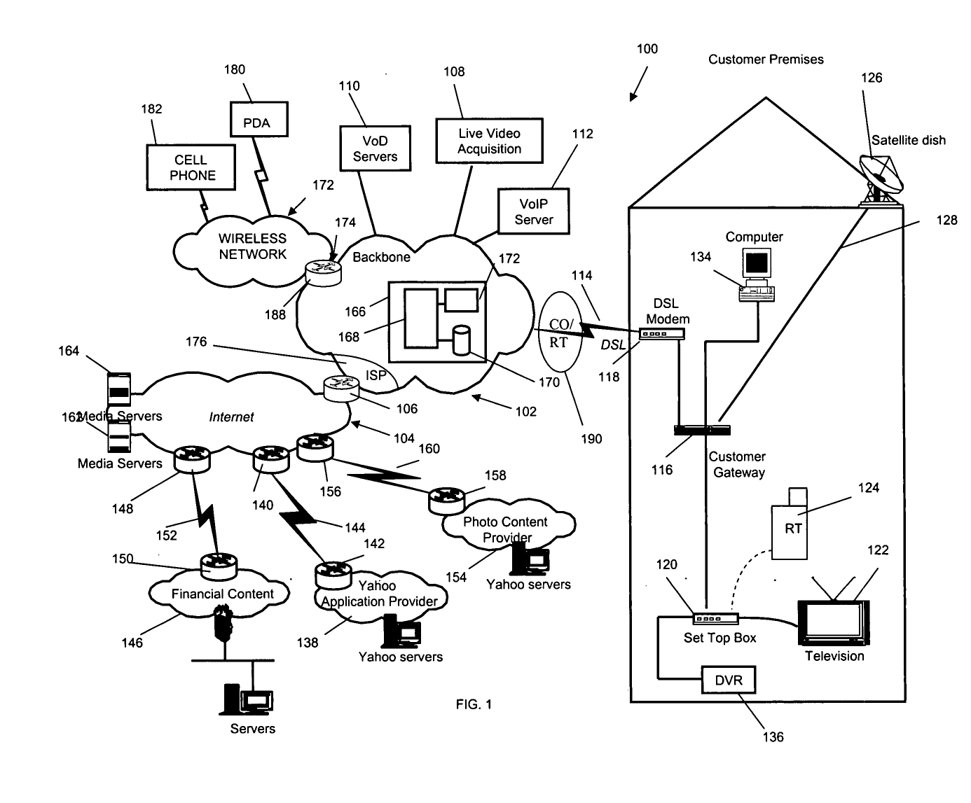

FIG. 1 shows a functional diagram of a network 100 for providing network content to customer premises equipment (CPE) over a data communication line or link according to one embodiment of the present disclosure. The network 100 is shown to include a backbone 102 (also referred to as a backbone network) of a service provider that may be coupled to the Internet 104 via an Internet Service Provider (ISP) 176 and one or more routers, such as a router 106. A common entity may act as the ISP and provide services via the backbone. The backbone 102 includes a variety of server systems 166 that include a variety of servers 168, associated databases 170 and a variety of computer programs 172. The backbone also contains a variety of transport links that provide high-speed data communication between the various network elements. The backbone 102 may be an Internet Protocol (IP) network, an Asynchronous Transfer Mode (ATM) network, a Packet Cable Network, or another suitable network. The backbone 102 is shown coupled to a live video acquisition system 108 (e.g., a live television content provider) that may provide multiple television channels such as commonly delivered over television networks. The backbone 102 also is shown coupled to Video-on-Demand (VOD) servers 110 that provide video content to customers and to Voice-over-Internet Protocol (VoIP) servers 112 that provide voice content to customers.

The backbone 102 is shown coupled via a digital subscriber line 114 to a DSL modem 118 that is then coupled to a customer gateway 116 (also referred to as the residential gateway (RG). The RG 116 may be a router and may be coupled to a set-top-box (STB) 120 that is connected to a television (TV) 122. The STB 120 may act as a control interface for the TV 122, be accessed by remote control 124, and be coupled to a digital video recorder (DVR) 136. One or more computers, such as computer 134, may also be coupled to the customer gateway 116. Alternative configurations for the CPE also may be used. The data transmission line or link may also be a cable connection or a satellite connection, such link 128, via a satellite dish 126.

The network 100 is further shown coupled of a number of content providers, (also referred herein as partners) over the Internet 104 (also referred to as the Public Internet). For example, the backbone 102 is shown coupled to a service provider “Yahoo” 138 via routers 140 and 142, and a link 144; a financial content provider 146 via routers 148 and 150, and a link 152; and a photo content provider 154 that provides photo albums stored by the customer over the Internet via routers 156 and 158, and a link 160. Similarly, the backbone 102 may be coupled to or have access to any other content provider (generally designated by number 162), such as an interactive gaming service that enables a customer to play games against other players, and a gaming service that enables a customer to bet online and settle accounts. The network 100 also may provide access to a variety of other services, such as multimedia services 164, and data centers that provide billing services, etc.

Still referring to FIG. 1, the backbone 102 is coupled to the CPE via a network element 190 at an end of the service provider's network, which element maybe a switch, such as a digital subscriber line access multiplexer (DSLAM), that is configured for a selected protocol. A single DSLAM typically connects to multiple (often 500-1000) customers via a separate line for each such customer. A separate port at the DSLAM is dedicated to each DSL. Several DSLAM units are typically placed in a central office (CO) that services a particular geographical area or at a remote terminal (RT) proximate a neighborhood. Each customer has a unique address that is stored in the database 170, which address may be an IP address, an identifier associated with the STB 120, or any other suitable identifier. In addition, the database 170 stores customer account numbers or identifiers that the customer has set up with partner content providers. In addition, the customer information may include account numbers for other relevant domains, such as broadband and voice, including VoIP, credit card numbers that may be charged for interactive activity by the customer, such as for buying merchandise, downloading videos, settling accounts, etc.

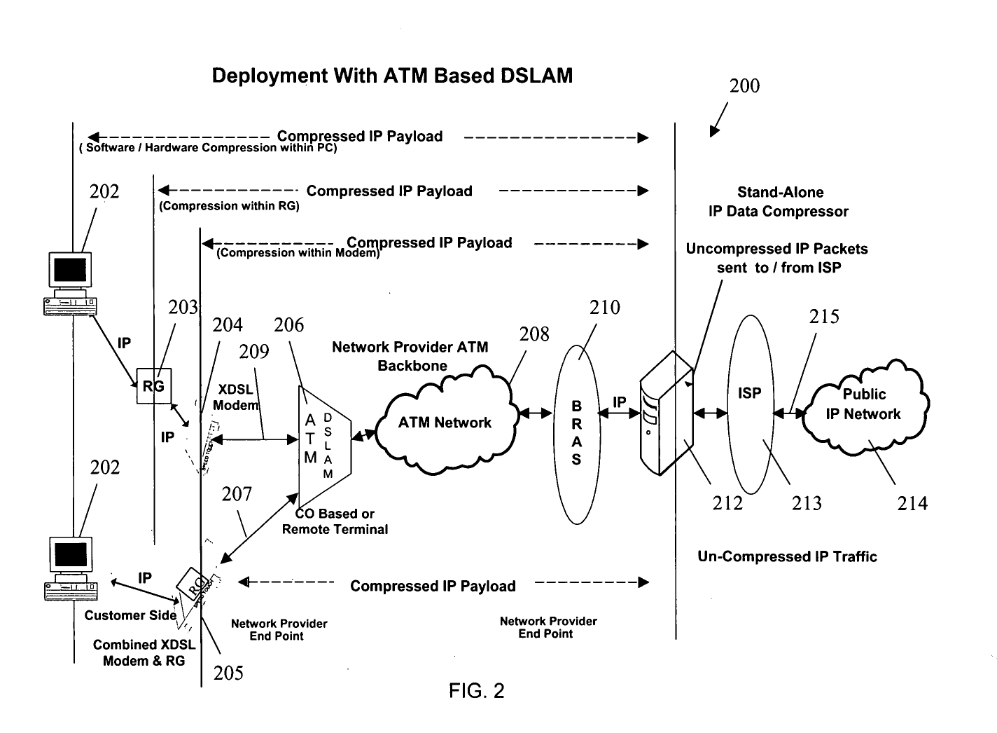

Still referring to FIG. 1, the backbone 102 is further shown coupled to a wireless network 172 via a router 174. The wireless network 172 may be coupled to a personal data assistant (PDA) 180 and to a cell phone 182. Thus, as shown in FIG. 1, the backbone 102 is connected at one end to the ISP, Internet, wireless networks, and/or other providers and at the other end to CPE. The present disclosure provides data compression and decompression methods and systems for content transferred between the CPE and network elements. In general, the downstream data may be compressed at any suitable element in the network, such as a DSLAM, a dedicated data compression server in the backbone, a terminal network element that communicates with the ISP or the Internet or another data compression device placed at a suitable location in the data path between CPE and ISP or Internet. CPE maybe configured to automatically decompress the received compressed downstream data and to compress the upstream data before transmitting it over the link to the backbone. Certain examples of the systems and methods for data compression and decompression are shown and described in reference to FIGS. 2-6.

FIG. 2 is a schematic diagram depicting a data compression/decompression system for an Asynchronous Transfer Mode (ATM) network 200 in accordance with one embodiment of the present disclosure. The network 200 is shown to include at the customer end an xDSL (DSL, ADSL, VDSL, etc.) modem 204 that connects to a switch, such as an ATM DSLAM 206, via a DSL 209 or another suitable link. The modem 204 may connect to one or more computers 202 via a residential gateway 203. The residential gateway may be any suitable router. Alternatively, the xDSL modem functions may be combined into the residential gateway 205 that then connects to the computers 202. Residential gateway 205 is shown connected to the ATM DSLAM via link 207. The ATM DSLAM 206 is shown connected to an ATM backbone network 208 that connects to a Broadband Remote Access Server (BRAS) 210. The BRAS 210 may connect to the Internet 214 via an ISP network 213 or through a stand-alone data compression/decompression server 212. The ISP 313 connects to the Internet via link 215. The operations and functions of ATM, BRAS and DSLAM are known in the art and are thus not described in detail herein. In general, however, a DSLAM typically acts as an end processor element at the backbone network side or end and provides network content to the CPE in the desired protocol. The DSLAM collects data traffic from multiple subscribers into a centralized point so that it can be uploaded to the routers in the backbone over Frame Relay, ATM or Ethernet. ATM is a cell relay network protocol that encodes traffic into small fixed-sized (53 bytes; 48 bytes of data and 5 bytes of header information) cells. ATM is a connection-oriented technology, in which connection is established between the two end points before the data exchange begins. The BRAS, in general, routes the data or traffic to and from the DSLAM on to an ISP network, such as network 213. The BRAS also aggregates the output from DSLAM units and provides point-to-point protocol (PPP) sessions or Internet Protocol over ATM services, and routes the traffic into service provider's backbone network. The routers provide the logical termination for PPP sessions as well the interface to an authentication and accounting system.

In one aspect of the present disclosure, data is compressed in the upstream and downstream directions. One or more data compression algorithms or programs are installed in one or more devices in the service provider's network for compressing the downstream data before transmitting the compressed data to CPE over the link 209 and for decompressing the compressed data received from the CPE before transmitting it to the ISP 213 or the Public Internet 214 or to another device outside the backbone network that is not configured to receive the compressed data. Similarly, suitable algorithms or programs are placed in or are accessible to the CPE for decompressing the compressed data received from the network and for compressing the data generated at the customer end before transmitting such data to the network 208 over the link 209. Typically, the payload, which generally forms the bulk portion of the transmitted data, is compressed in both the upstream and downstream directions. The header and other portions are often nor compressed. The header is tagged to indicate that the data is compressed, which the program at the receiving end can identify and perform the decompression of such received data.

In the example of the network of FIG. 2, at the customer end, data compression and decompression may be done in the xDSL modem 204, RG 203, in the combined RG/Modem 205 or in the computer 202. At the network end, the data compression and decompression may be done at the ATM DSLAM 206, another server in the backbone 208, the BRAS 210 or at the stand-alone server 212. Thus, the data that is received by the CPE is compressed and decompressed to the appropriate format, such as IP format, and the data that is received at the network from the CPE is likewise decompressed into IP format before transmitting to the ISP or the Public Internet. Thus, in the present disclosure, in one aspect a first processor (at a computer 202, modem 204, RG 203, or other device) uses one or more compression computer programs to compress the upstream data payload and decompresses the downstream data payload, while a second processor (in the DSLAM, a backbone server, BRAS, a stand-alone server, etc.) executes one or more compression programs to compress the downstream payload and decompresses the upstream payload. Accordingly, in one aspect, all of the payload or any part of the data stream may be compressed and decompressed for transmission, thereby providing enhanced data speed and the bandwidth.

In the system of FIG. 2, the data to be compressed may be generated by a user device, such as the computer 202, and at the network end by an application executing anywhere within the network 200, such as at a content provider, etc. Suitable processors or servers compress the uncompressed data and uncompress the compressed data. The data compression and decompression programs may be stand-alone computer programs or may be integrated within other software. The data may include any type of data, such as movies, VOD, photographs, word processing documents, spreadsheet data, voice, etc.

The compression/decompression instructions may be independent of data type or may automatically adapt to data type and may achieve data compression ratios that facilitate efficient transfer of data over the DSL link. For example, the instructions may implement a compression and decompression algorithm in accordance with an ITU-U V.44 approach (or similar standard approaches) to compression/decompression to achieve a 6× (i.e., 6:1) compression ratio, allowing increased data rates. Typical downstream data rates between 384 kbps and 64 Mbps may thus be substantially enhanced. For example, a data rate of 128 Kbps may be enhanced to a data rate of 768 Kbps. A data rate of 384 Kbps may be enhanced to a data rate of 2304 Kbps. A data rate of 1024 Kbps may be enhanced to a data rate of 6144 Kbps. A data rate of 6 Mbps may be enhanced to a data rate of 36 Mbps.

Similarly, in a cable network (described later), the compression ratio may also be 6×. If an Expected Maximum Shared Channel Data Rate (EMSCDR) is 10 Mbps, such might be expected in a cable network compliant with DOCSIS version 1.0 or 1.1, then an EMSCDR of the compressed downstream data may be 60 Mbps (10 Mbps×6=60 Mbps). If an EMSCDR is 30 Mbps, which might be expected in a cable network compliant with DOCSIS version 2.0, then an EMSCDR of the compressed downstream data may be 180 Mbps (30 Mbps×6=180 Mbps).

In one aspect, a first processor associated with the network or CPE and a second processor at the CPE or Network may have a predetermined compression ratio or may have an adaptive compression ratio based upon an available bandwidth. Accordingly, if the amount of a downstream data far exceeds the amount of the upstream data, then the processors may select a more aggressive compression algorithm or a more aggressive compression ratio for downstream transmission than for upstream transmission. In another aspect, the instructions pertaining to decompression may include instructions that examine the data to determine whether decompression is appropriate. The decompression may be independent of the data type or may automatically adapt to the data type.

In another aspect, the compression/decompression device or the associated programs may determine whether data is compressed. The determination may be based upon the data type or based upon the processor that generated the application data. The client interface may also have a user interface, such as a switch or dialog box to allow the client to toggle between an “on” mode and an “off” mode to switch between the compression and non-compression modes. The computer program at the customer end may contain instructions to compress upstream data in response to an “on” mode of a user interface and not compress data in response to an “off” mode.

In another aspect, the compression algorithm and the compression ratio may be determined by a “handshake” phase when transmission is begun, e.g. a flag indicating the compression algorithm and the compression ratio may be included in a header block. If desired, a compression ratio associated with the computer program may be adjustable by the user or by an application with which the data is associated. If desired, the user may be prompted to select a compression algorithm and compression ratio, or a compression algorithm and compression ratio may be selected by default.

The computer-readable medium in which the programs are embedded and the processors that perform the data compression and/or decompression need not be located physically near the customer premises equipment and may reside anywhere within the compression network 200, regardless of whether the compression network 200 is a DSL network, a cable network, an IP network, a local area network (LAN), a wide area network (WAN), a satellite network, and/or an Ethernet network. Suitable locations may include a remote DSL terminal, or a cable terminal, a service terminal (such as a DSLAM within the DSL link 114 of FIG. 1, which can be a significant distance from the customer premises) or a residential gateway of another customer or of a building within which the customer premises is located, or any other network device to which the customer premises equipment may be coupled. The processor may also be located within a router such as an edge router, a Broadband Remote Access Server (BRAS), or within an Internet Service Provider (ISP) that provides access to the Internet or other public Internet Protocol (IP) network.

In one aspect, a first processor for compressing/decompressing data may also be integrated into a peripheral device. For example, the processor may be integrated into a photograph scanner, digital video camera, or other device that creates digital content to be stored or archived. The computer, processor, peripheral device, or other device into which the processor is integrated may include custom software for use in a particular industry. For example, the set-top-box application may receive Video-On-Demand (VoD) data from the network. The VoD data may be addressed to a particular application that is executing on the computer 202, such as a teleconferencing application or a media player. The computer program may provide an interface between the DSL link and the particular application that is addressed, decompressing the VoD data for presentation by the teleconferencing application or the media player.

The second processor may be associated with a server located at a network termination of a cable modem termination system (CTMS), or may be a separate compression/decompression server (i.e., a stand-alone data compressor, or “SADC”) at a Head End Switch/Backbone Transport Adaptor between the head end switch at the backbone or a central office. The second processor may further toggle between an “enable” mode and a “disable” mode (in response to a determination whether the upstream network data is compressed) to decompress upstream IP data (i.e., the compressed upstream network data) that is received over the network 200 from the CPE.

As described above, the computer program and the first processor can selectively compress the upstream data and also decompress the downstream data. However, in other implementations, multiple computer programs and multiple processors may be used. Also, multiple networks may be used; the network that carries the downstream data may or may not be the same network as the network that carries the upstream data. Upstream data may have a much smaller bandwidth and so may be much more heavily multiplexed with other customers than the downstream data, which may be multicast to many customers. For example, a single narrow upstream channel may be provided to each customer, and each customer may compress data for upstream transmission, while a few downstream channels may suffice for an entire neighborhood and may be decompressed at a DSLAM. Other implementations are also contemplated, in some of which a single network is used, and in others of which multiple networks are used.

The computer program decompresses the downstream network data that is received over the communication link. If the computer program is coupled to more than one processor, then the computer program determines which processor should receive the downstream network data. The computer program provides the downstream network data to the processor.

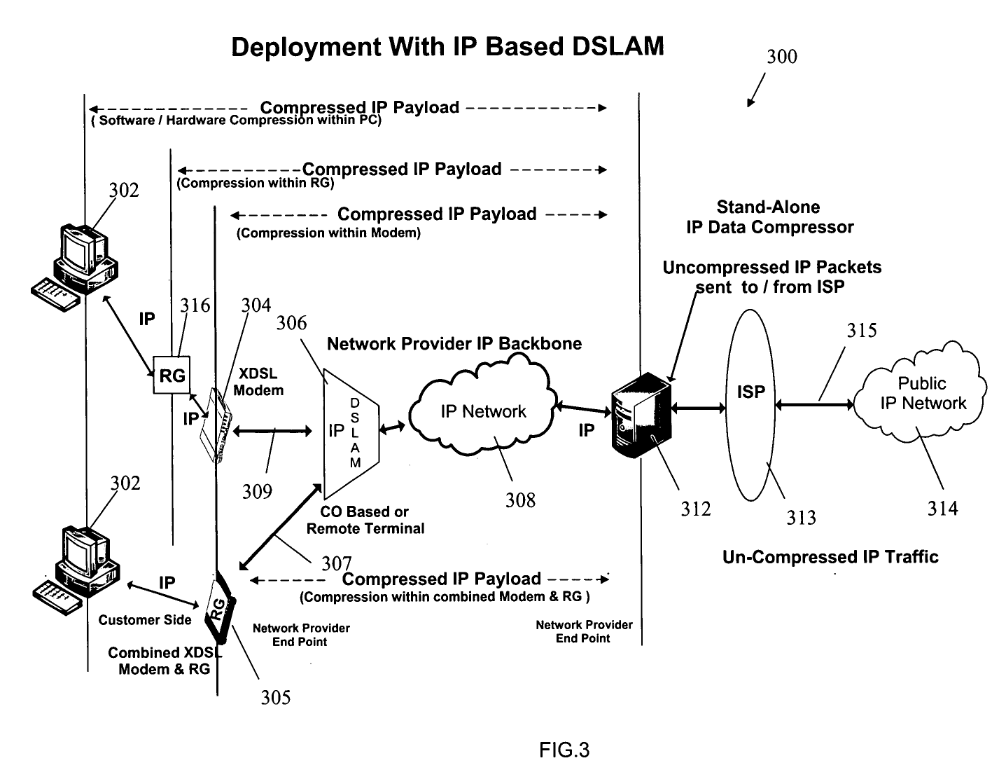

FIG. 3 is a schematic diagram depicting a network 300 that includes an IP backbone network instead of an ATM backbone network of FIG. 2. The network 300 is shown to include an xDSL modem 304 that is coupled to an IP DSLAM 306 via link 309. The modem 304 is coupled to a computer 302 via an RG 316. Alternatively, the functions of the RG 316 and modem 304 may be combined into a common device 305 that is then coupled to another device, such as the computer 302. The IP DSLAM is shown coupled to the IP backbone network 308 that may be directly coupled to the ISP 313 or via a stand-alone data compressor/decompressor server 312. The ISP 313 connects to the Internet via link 315. The data compression/decompression techniques and methods for the network 300 are similar to the techniques and methods described in reference to the network of FIG. 2, except that the applications are configured for an IP Network. At the network side, the data compression/decompression may be done at the DSLAM 306, a server in the backbone network 308, or at the stand-alone server 312 substantially in the same manner as described above with respect to FIG. 2. The data compression/decompression at the CPE may be done at xDSL modem 304, RG 316, combined modem/RG 305, computer 302 or at another suitable device in the manner described in reference to FIG. 2.

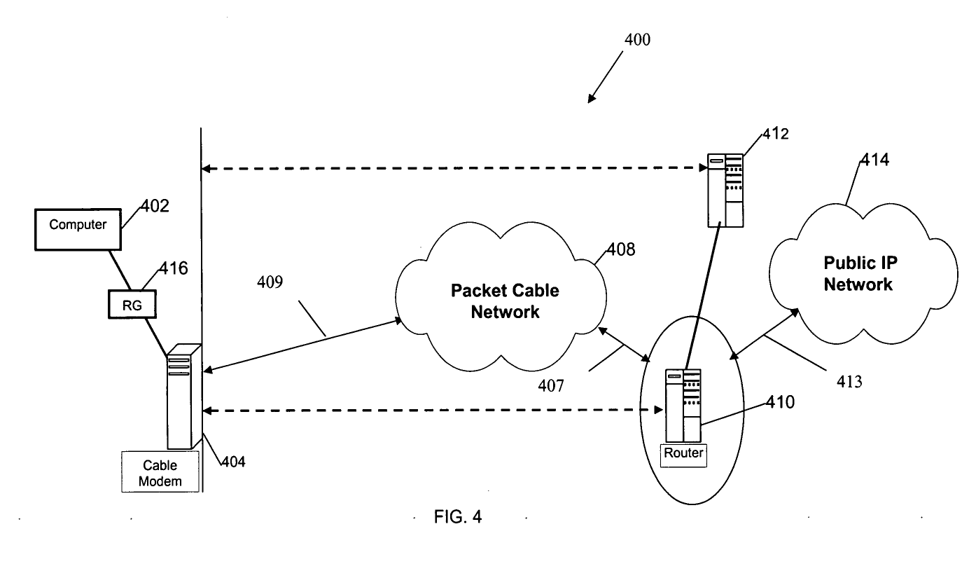

FIG. 4 is a schematic diagram depicting a network 400 that includes a Packet Cable Network instead of a DSL network shown in FIG. 2 and FIG. 3 according to an embodiment of the present disclosure. The network 400 is shown to include a cable modem 404 that is coupled to a computer 402 via a residential gateway 416. The functions of the cable modem and the RG 416 may be combined in a single device. The cable modem connects to the Packet Cable Network 408 via a cable, such as a coaxial or hybrid coaxial and fiber cable 409. The Packet Cable Network then connects to the Public IP Network 414 through a router 410 via links 407 and 413. The compression network 400 also may include a Stand Alone Data Compressor (SADC) 412 that may be placed on the link 407 or 413. The Stand Alone server may compress/decompress the data between the Packet Cable Network or between the router 410 and the Public IP Network. In other aspects, as described in reference to FIGS. 2 and 3, the data may be compressed and decompressed at any of the CPE and at any other suitable element in the network 400. The computer programs and instructions for compression and decompression are similar to those described above and the data between the Packet Network and the CPE is transferred over the cable connection 409.

Thus, the compression/decompression programs may reside at any suitable device within the a cable network, an IP network, a local area network (LAN), a wide area network (WAN), a satellite network, an Ethernet network, a residential gateway of another customer or a building within which the customer premises' is located, a service terminal, or any other suitable device. Accordingly, in one aspect, payload or a part thereof passing through a link coupled between a CPE and backbone network may be compressed, such that the link has an enhanced bandwidth. Thus, a first processor may transmit compressed data to the second processor across the link and the second processor may transmit compressed data to the first processor across the link. Each processor decompresses the data received from the other processor. The computer programs associated with data compression and decompression may reside within a network termination of a cable modem termination system (CTMS), within a Head End Switch/Backbone Transport Adaptor, or within a separate compression/decompression server between the head end switch and backbone. Thus, the networks depicted in FIGS. 2-4 may operate substantially in the same manner. For example, in FIG. 4, a cable modem replaces the DSL modem of FIG. 2 and a packet cable infrastructure replaces a DSL infrastructure. Thus, compression/decompression algorithms, the suitable location of processors and computer-readable media, and interoperability with applications at the customer premises, the central office and the backbone network are implemented according to the type of the network.

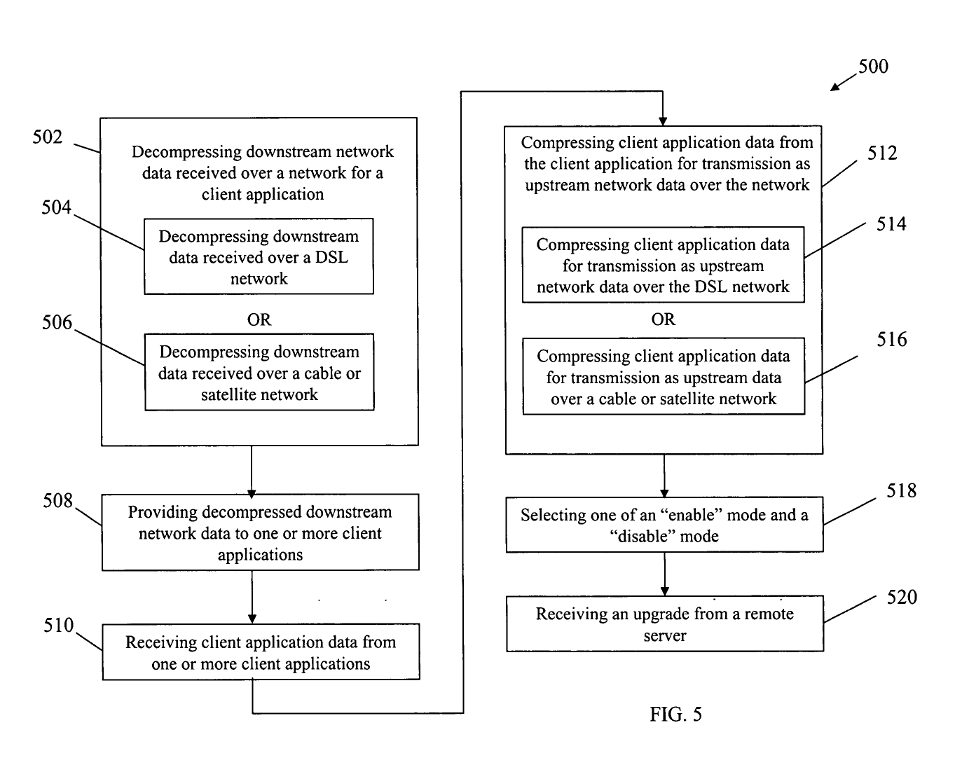

FIG. 5 shows a flow chart of an exemplary method 500 according to one aspect of the present disclosure. As shown a block 502, the method includes decompressing at the customer end compressed downstream data received over a communication link from a network for a client application. For example, the compressed downstream data may be received over a DSL network (Block 504), or a cable or satellite network (Block 506). The decompressed downstream data is then provided to one or more client applications or CPE. Also, at the customer end, the client application data is received (Block 510) and then compressed (Block 512) for transmission as upstream data over the communication link to the network. The client application data may be compressed for transmission as upstream data over a DSL network (Block 514), or a cable or satellite network (Block 516).

As shown at Block 518, the method provides for the selection of an “enable” mode or a “disable” mode. A user or a process executing within the network may toggle a compression mode from enable to disable, or from disable to enable. When in the disable mode, the method does not compress data, and does not decompress data. The disable mode may facilitate interoperability with legacy networks and with legacy applications, and may speed up transmission when a client application's bandwidth requirements are so small that compression itself can impose a relatively significant processing burden. The toggling may be controlled by a meta-application that examines a data requirement for each client application and determines whether to enable or disable compression. Disabling of decompression may be overridden when the downstream network data itself contains a flag indicating that the downstream network data is compressed.

At block 520, the method includes receiving an upgrade for the compression/decompression programs from a remote server. At block 520, the computer program itself may be altered or updated. New instructions may be received to supplement or replace instructions within the computer program, or instructions may be deleted or rearranged. The computer-readable medium may be implemented as a distributed set of physical media each of which is located in a different location.

At the network end, the downstream data is received from a data source, compressed at the network side and transmitted to the customer premises over the communications link. The compressed upstream data received at the network is decompressed before sending such data outside the service provider network.

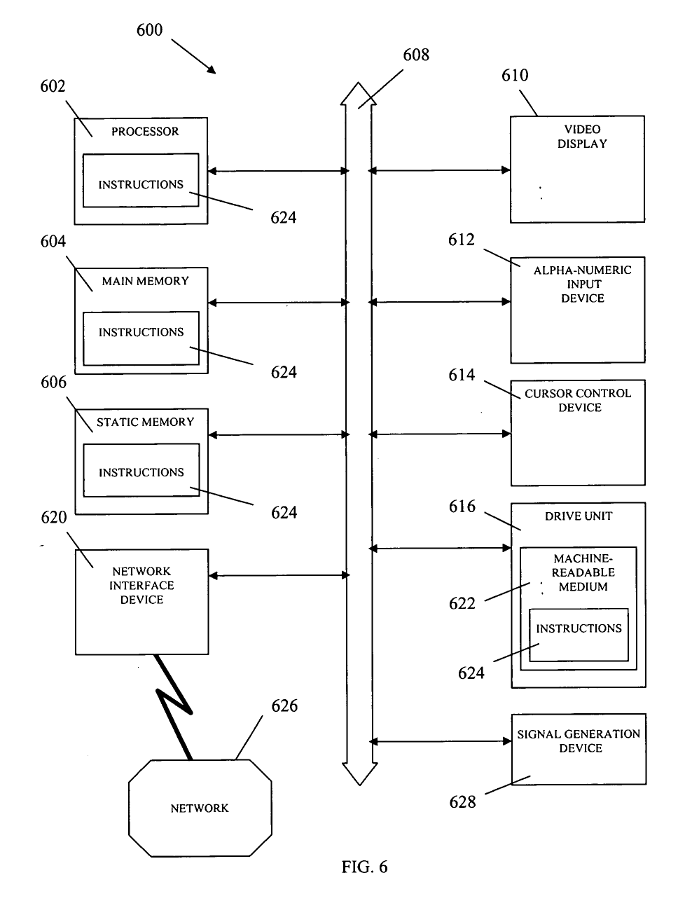

FIG. 6 is a diagrammatic representation of a machine in the form of a computer system 600 within which a set of instructions, when executed, may cause the machine to perform any one or more of the methodologies discussed herein. In some embodiments, the machine operates as a standalone device. In some embodiments, the machine may be connected (e.g., using a network) to other machines. In a networked deployment, the machine may operate in the capacity of a server or a client user machine in server-client user network environment, or as a peer machine in a peer-to-peer (or distributed) network environment. The machine may comprise a server computer, a client user computer, a personal computer (PC), a tablet PC, a set-top box (STB), a Personal Digital Assistant (PDA), a cellular telephone, a mobile device, a palmtop computer, a laptop computer, a desktop computer, a personal digital assistant, a communications device, a wireless telephone, a land-line telephone, a control system, a camera, a scanner, a facsimile machine, a printer, a pager, a personal trusted device, a web appliance, a network router, switch or bridge, or any machine capable of executing a set of instructions (sequential or otherwise) that specify actions to be taken by that machine. It will be understood that a device of the present disclosure includes broadly any electronic device that provides voice, video or data communication. Further, while a single machine is illustrated, the term “machine” shall also be taken to include any collection of machines that individually or jointly execute a set (or multiple sets) of instructions to perform any one or more of the methodologies discussed herein.

The computer system 600 may include a processor 602 (e.g., a central processing unit (CPU), a graphics processing unit (GPU), or both), a main memory 604 and a static memory 606, which communicate with each other via a bus 608. The computer system 600 may further include a video display unit 610 (e.g., a liquid crystal display (LCD), a flat panel, a solid state display, or a cathode ray tube (CRT)). The computer system 600 may include an input device 612 (e.g., a keyboard), a cursor control device 614 (e.g., a mouse), a disk drive unit 616, a signal generation device 618 (e.g., a speaker or remote control) and a network interface device 620.

The disk drive unit 616 may include a machine-readable medium 622 on which is stored one or more sets of instructions (e.g., software 624) embodying any one or more of the methodologies or functions described herein, including those methods illustrated in herein above. The instructions 624 may also reside, completely or at least partially, within the main memory 604, the static memory 606, and/or within the processor 602 during execution thereof by the computer system 600. The main memory 604 and the processor 602 also may constitute machine-readable media. Dedicated hardware implementations including, but not limited to, application specific integrated circuits, programmable logic arrays and other hardware devices can likewise be constructed to implement the methods described herein. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

In accordance with various embodiments of the present disclosure, the methods described herein are intended for operation as software programs running on a computer processor. Furthermore, software implementations can include, but not limited to, distributed processing or component/object distributed processing, parallel processing, or virtual machine processing can also be constructed to implement the methods described herein.

The present disclosure contemplates a machine readable medium containing instructions 624, or that which receives and executes instructions 624 from a propagated signal so that a device connected to a network environment 626 can send or receive voice, video or data, and to communicate over the network 626 using the instructions 624. The instructions 624 may further be transmitted or received over a network 626 via the network interface device 620.

While the machine-readable medium 622 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present disclosure. The term “machine-readable medium” shall accordingly be taken to include, but not be limited to: solid-state memories such as a memory card or other package that houses one or more read-only (non-volatile) memories, random access memories, or other re-writable (volatile) memories; magneto-optical or optical medium such as a disk or tape; and carrier wave signals such as a signal embodying computer instructions in a transmission medium; and/or a digital file attachment to e-mail or other self-contained information archive or set of archives is considered a distribution medium equivalent to a tangible storage medium. Accordingly, the disclosure is considered to include any one or more of a machine-readable medium or a distribution medium, as listed herein and including art-recognized equivalents and successor media, in which the software implementations herein are stored.

Although, the present specification describes components and functions implemented in the embodiments with reference to particular standards and protocols, the disclosure is not limited to such standards and protocols. Each of the standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same functions are considered equivalents.

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of skill in the art upon reviewing the above description. Other embodiments may be utilized and derived there from, such that structural and logical substitutions and changes may be made without departing from the scope of this disclosure. Figures are merely representational and may not be drawn to scale. Certain proportions thereof may be exaggerated, while others may be minimized. Accordingly, the specification and drawings are to be regarded in an illustrative rather than a restrictive sense.

Such embodiments of the inventive subject matter may be referred to herein, individually and/or collectively, by the term “disclosure” merely for convenience and without intending to voluntarily limit the scope of this application to any single disclosure or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. A computer-readable medium accessible to a processor for executing instructions contained in a computer program embedded in the computer-readable medium, the computer program comprising:
instructions to receive a compressed first data stream as a downstream data from a network element of a network over a data communication link;
instructions to decompress the compressed first data stream;
instructions to provide the decompressed first data stream to a customer premises equipment (CPE);
instructions to receive a second data stream from the CPE for transmission to the network element as upstream data;
instructions to compress the second data stream; and
instructions to transmit the compressed second data stream as upstream data to the network element over the data communication link.

2. The computer-readable medium of claim 1, wherein the computer program further comprises instructions to decompress the compressed second data stream and compress the first data stream.

3. The computer-readable medium of claim 1, wherein the data communication link is one of a: digital subscriber line, cable, and wireless link.

4. The computer-readable medium of claim 1, wherein the network element is one of a: digital subscriber line access multiplexer (DSLAM); cable network interface; wireless network interface; and stand-alone server.

5. The computer-readable medium of claim 1, wherein the first data stream and the second data stream each is associated with one of: an Asynchronous Transfer Mode DSL Network; an Internet Protocol DSL network; and a Cable Packet network.

6. The computer-readable medium of claim 1, wherein the computer program further comprises at least one data compression and decompression algorithm that resides in one of a: DSL modem; Residential Gateway; computer; and cable modem.

7. The computer-readable medium of claim 2, wherein the computer program further comprises: instructions to decompress the compressed first data stream using a first ratio and compress the second data stream using a second ratio.

8. The computer-readable medium of claim 2, wherein the computer program further comprises instructions to compress the first and second data streams for transmission as one of: IP data; ATM data; cable network data; and satellite network data.

9. The computer-readable medium of claim 1, wherein the computer program further comprises instructions to select one of: an enable mode that activates a data compression and decompression algorithm; and a disable mode that deactivates the data compression and decompression algorithm.

10. An apparatus for use as an interface between a CPE and a communications network that provides content to the CPE over a data communication link, the apparatus comprising:
a processor;
a computer-readable medium accessible to the processor for executing instructions contained in the computer program embedded in the computer-readable medium, the computer program comprising:
instructions to receive a compressed first data stream as a downstream data from a network element of the communication network over a data communication link;
instructions to decompress the compressed first data stream;
instructions to provide the compressed first data stream to a customer premises equipment (CPE);
instructions to receive a second data stream from the CPE for transmission to the network element as upstream data;
instructions to compress the second data stream; and
instructions to transmit the compressed second data stream as upstream data to the network element over the data communication link.

11. The apparatus of claim 10, wherein the first data stream and the second data stream each is associated with one of: an Asynchronous Transfer Mode DSL Network; an Internet Protocol DSL network; and a Cable Packet network.

12. The apparatus of claim 10, wherein the computer program and the processor reside in one of a: DSL modem; Residential Gateway; computer; and cable modem.

13. The apparatus of claim 10, wherein the computer program further comprises instructions to decompress the compressed first data stream at a first ratio and compress the second data stream at a second ratio.

14. The apparatus of claim 10, wherein the computer program further comprises instructions to select one of: an enable mode that activates a data compression and decompression algorithm; and a disable mode that deactivates the data compression and decompression algorithm.

15. A method for providing network payload compression, the method comprising:
decompressing downstream network data received over a communication link from a network for a client application; and
compressing client application data received from the client application before transmission of the client application data as upstream data over the communication line to the network.

16. The method of claim 15, further comprising: compressing downstream network data before transmission over the communication link for the client application, and decompressing the compressed client application data before transmission to the Internet.

17. A system for providing network payload compression, the system comprising:
a client interface operative to decompress downstream network data received over a network for a client application, and further operative to compress client application data received from the client application for transmission as upstream network data over the network, and
a network interface operative to compress the downstream network data and provide the compressed downstream network data over the network to the client interface, and further operative to decompress the compressed upstream network data received from the client interface over the network.

18. The system of claim 1, wherein the client interface resides in one of a modem, RG, and computer at a customer premises; and wherein the network interface resides in one of a DSLAM, BRAS, and a server between a backbone network and the Internet.

19. A method for compressing and decompressing data in a communications network, comprising:
receiving compressed first data stream as downstream data from a network element over a data communication link;
decompressing the first data stream and sending the decompressed first data stream to a customer premises equipment (CPE);
receiving a second data stream from the CPE for transmission to the network element as upstream data;
compressing the second data stream;
transmitting the compressed second data stream as upstream data to the network element over the data communication link; and
decompressing the compressed second data stream received as the upstream data at the network element.

20. The method of claim 19, wherein the first data stream and the second data stream each is associated with one of: an Asynchronous Transfer Mode DSL Network; an Internet Protocol DSL network; and a Cable Packet network.

21. The method of claim 19, wherein a first processor in the network end compresses the first data stream and decompresses the compressed second data stream and a second processor at the customer premises compresses the second data stream and decompresses the compressed first data stream.

22. The method of claim 21, wherein the second processor resides in one of a: DSL modem; Residential Gateway; computer; and cable modem.

23. The method of claim 21, wherein the first processor is associated with one of a DSLAM, BRAS, and a stand-alone server.

24. The method of claim 19 further comprising updating the computer program from a remote location over the communications link.
